(19) United States
(12) Patent Application Publication
(10) Pub. No.: US 2003/0062792 A1
(43) Pub. Date: Apr. 3, 2003

(54) Manufacturing method and composite powder metal rotor assembly for spoke type interior permanent magnet machine

(76) Inventors: Frederick B. Reiter JR., Cicero, IN (US); James L. Lobsinger, Fishers, IN (US); Tom L. Stuart, Pendleton, IN (US); Frank A. Wilder, Indianapolis, IN (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 09/970,106

(22) Filed: Oct. 3, 2001

(51) Int. Cl. H02K 21/12

(52) U.S. Cl. 310/156.56

(57) ABSTRACT

A composite powder metal disk for a rotor assembly in a spoke type interior permanent magnet machine. The disk includes an inner ring of magnetically non-conducting powder metal compacted and sintered to a high density. The disk further includes an outer ring of radially extending permanent magnets separated by magnetically conducting powder metal compacted and sintered to a high density. The permanent magnets additionally are radially embedded by magnetically non-conducting powder metal compacted and sintered to a high density. A rotor assembly is also provided having a plurality of the composite powder metal disks mounted axially along a shaft with their magnetic configurations aligned. A method for making the composite powder metal disks is further provided including filling a die with the powder metals, compacting the powders, and sintering the compacted powders.

### FIELD OF THE INVENTION

This invention relates generally to interior permanent magnet machines, and more particularly, to the manufacture of rotors for a spoke type interior permanent magnet machine.

### BACKGROUND OF THE INVENTION

It is to be understood that the present invention relates to generators as well as to motors, however, to simplify the description that follows, a motor will be described with the understanding that the invention also relates to generators. With this understanding, there are two types of interior permanent magnet motors (IPM motors). In one type, the magnets face the air gap between the rotor and stator and are called circumferential IPM motors. In the other type, the magnets are orthogonal to the air gap, like spokes. The spoke type IPM motor has the advantage that two magnets contribute their flux to each pole resulting in a flux concentration effect. The spoke type IPM motor may allow higher power output than the circumferential IPM motor, assuming that there are no significant flux losses due to flux leakage. In current spoke type IPM motors, however, there is significant flux leakage around both ends of the magnet. This is due to the substantial amounts of electrical steel necessary for holding the permanent magnets in place, even for rotation at normal operating speeds. Thus, flux leaks from the front side of the magnet to the back side of the magnet through the electrical steel at the ends of the magnet required for structural stability of the rotor. The electrical steel consists of stacked stamped steel laminations. These individual laminations are independently fabricated. The resulting assembly is structurally weak.

There is thus a need to develop an IPM machine of the spoke type with reduced flux leakage, and preferably that may be produced at a lower cost than that of currently fabricated IPM motors.

### SUMMARY OF THE INVENTION

The present invention provides a composite powder metal rotor assembly for a spoke type IPM machine having mounted on a shaft disks of an inner annular non-ferromagnetic powder metal segment and an outer annular permanent magnet segment with a plurality of alternating polarity, radially extending permanent magnets separated by soft ferromagnetic powder metal segments and capped by non-ferromagnetic powder metal segments. Thus, both ends of the permanent magnets are bordered by a structurally robust non-ferromagnetic powder metal material to thereby minimize flux leakage around the magnet ends. There is further provided a method of making such a composite powder metal rotor assembly in which a die is filled according to this desired magnetic pattern, followed by pressing the powder metal and sintering the compacted powder metal to achieve a high density composite powder metal disk of high structural stability in which the permanent magnets may be inserted. These disks are then stacked axially along a shaft with their magnetic patterns aligned to form the powder metal rotor assembly. An interior permanent magnet machine incorporating the powder metal rotor assembly of the present invention exhibits minimal flux leakage and may permit the motor to produce more power than a circumferential IPM motor or to produce the same power using less powerful and less expensive magnets, and may be produced at a lower overall cost.

These and other objects and advantages of the present invention shall become more apparent from the accompanying drawings and description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of a powder metal rotor assembly of the present invention having a plurality of disks stacked along a shaft, each disk having a plurality of interior spoke type permanent magnets;

FIG. 1A is a plan view of the assembly of FIG. 1;

FIGS. 2A-2B are plan views of alternative disks;

FIG. 3 is a perspective view of an insert for use in a method of the present invention;

FIG. 4 is a perspective view of an inner bowl and outer bowl of a hopper that may be used for the filling aspect of the present invention;

FIGS. 5A-5E are cross-sectional schematic views of a method of the present invention using the insert of FIG. 3 and the hopper of FIG. 4 to produce the rotor assembly of FIGS. 1 and 1A;

FIG. 6 is a perspective view of an insert for use in an alternative method of the present invention; and

FIGS. 7A-7C are cross-sectional schematic views of the present invention using the insert of FIG. 6 and the hopper of FIG. 4 to produce the rotor assembly of FIGS. 1 and 1A.

### DETAILED DESCRIPTION

The present invention provides composite powder metal rotor components for rotor assemblies in spoke type interior permanent magnet machines. Permanent magnet machines incorporating the composite powder metal components exhibit high power density and efficiency and high speed rotating capability. To this end, and in accordance with the present invention, a plurality of powder metal disks or laminations are fabricated to comprise an inner annular magnetically non-conducting segment and an outer annular permanent magnet segment or ring.

The outer annular permanent magnet segment comprises a plurality of orthogonally positioned permanent magnets separated by magnetically conducting segments. At the outer radial end of each permanent magnet, between magnetically conducting segments, are magnetically non-conducting segments referred to herein as radially outer magnetically non-conducting segments. These non-conducting segments together with the magnetically conducting segments embed the permanent magnets within the disk.

The magnetically conducting segments comprise a pressed and sintered soft ferromagnetic powder metal. In an embodiment of the present invention, the soft ferromagnetic powder metal is nickel, iron, cobalt or an alloy thereof. In another embodiment of the present invention, this soft ferromagnetic metal is a low carbon steel or a high purity iron powder with a minor addition of phosphorus, such as covered by MPIF (Metal Powder Industry Federation) Standard 35 F-0000, which contains approximately 0.27% phosphorus. In general, AISI 400 series stainless steels are magnetically conducting, and may be used in the present invention.

The permanent magnet segment or ring comprises a series of alternating polarity permanent magnets, such as ferrite or rare earth permanent magnets. Depending on the particular machine, it is within the skill of one in the art to determine the appropriate number and size of permanent magnets to be spaced around the disk. The permanent magnets may be either prefabricated magnets affixed to the inner annular segment and the magnetically conducting segments, or pressed and sintered hard ferromagnetic powder metal.

The inner annular and radially outer magnetically non-conducting segments comprise pressed and sintered non-ferromagnetic powder metal. In an embodiment of the present invention, the non-ferromagnetic powder metal is austenitic stainless steel, such as SS316. In general, the AISI 300 series stainless steels are non-magnetic and may be used in the present invention. Also, the AISI 8000 series steels are non-magnetic and may be used.

In an embodiment of the present invention, the non-ferromagnetic metal of the inner annular and radially outer magnetically non-conducting segments and the soft ferromagnetic metal in the outer annular permanent magnet segment are chosen so as to have similar densities and sintering temperatures, and are approximately of the same strength, such that upon compaction and sintering, the materials behave in a similar fashion. In an embodiment of the present invention, the soft ferromagnetic powder metal is Fe-0.27% P and the non-ferromagnetic powder metal is SS316.

The powder metal disks of the present invention typically exhibit magnetically conducting segments having at least about 95% of theoretical density, and typically between about 95%-98% of theoretical density. Wrought steel or iron has a theoretical density of about 7.85 gms/cm³, and thus, the magnetically conducting segments exhibit a density of around 7.46-7.69 gms/cm³. The non-conducting segments of the powder metal disks of the present invention exhibit a density of at least about 85% of theoretical density, which is on the order of about 6.7 gms/cm³. Thus, the non-ferromagnetic powder metals are less compactable than the ferromagnetic powder metals. The pressed and sintered hard ferromagnetic powder metal magnets of certain embodiments of the present invention exhibit a density of at least 95.5% ± about 3.5% of theoretical density, depending on fill factor, which is on the order of about 3.8-7.0 gms/cm³.

The powder metal disks or rings can essentially be of any thickness. These disks are aligned axially along a shaft and mounted to the shaft to form a rotor assembly. The shaft is typically equipped with a key and the individual disks have a keyway on an interior surface to align the disks to the shaft upon attaching the part to the shaft. In an embodiment of the present invention, the individual disks or rings have a thickness on the order of about ⅜ to ⅞ inches. As disk thicknesses increase, the boundaries between the powder metal conducting segments, the powder metal non-conducting segments, and the powder metal permanent magnets may begin to blur. In practice, up to 13 disks of the present invention having a ⅜ to ⅞ inch thickness are suitable for forming a rotor assembly. There is, however, no limit to the thickness of each disk or the number of disks that may be utilized to construct a rotor assembly. The individual disks are aligned with respect to each other along the shaft such that the magnetic flux paths are aligned. The non-ferromagnetic powder metal at the ends of each permanent magnet minimizes flux leakage from one side of the magnet to the other around the magnet ends and increases the structural stability of the assembly. This arrangement allows better direction of magnetic flux with low flux leakage and improves the torque of the rotor assembly.

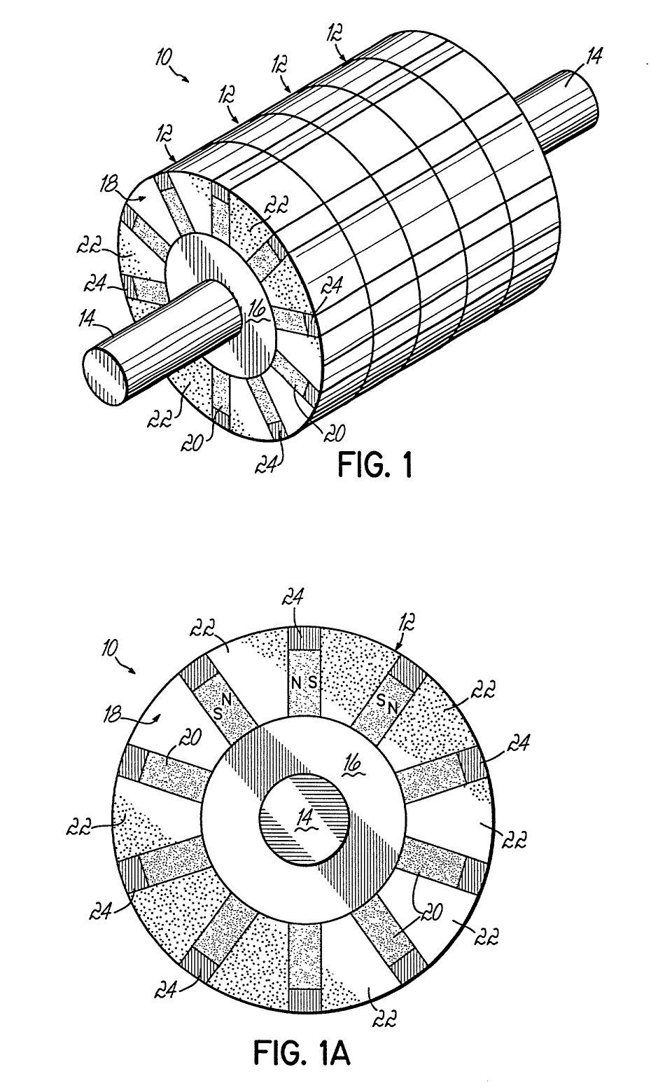

With reference to the Figures in which like numerals are used throughout to represent like parts, FIGS. 1 and 1A depict in perspective view and plan view, respectively, a powder metal rotor assembly 10 of the present invention having a plurality of powder metal composite disks 12 stacked along a shaft 14, each disk 12 having an inner annular magnetically non-conducting segment 16 and an outer annular permanent magnet segment 18 comprising a plurality of alternating polarity permanent magnets 20. The disks are aligned from one disk 12 to another along the length of the shaft 14.

The outer annular permanent magnet segment 18 includes magnetically conducting segments 22 separating the permanent magnets 20. The permanent magnet segment 18 further includes a radially outer magnetically non-conducting segment 24 adjacent each permanent magnet 20 that embeds the permanent magnet 20 in the disk 12. The conducting segments 22 direct the magnetic flux from between adjacent permanent magnets 20 out of the disk 12, around non-conducting segments 24, and back into adjacent conducting segments 22.

The permanent magnets 20 may be comprised of powder metal pressed sequentially or concurrently with the powder metals used to form the inner annular magnetically non-conducting segment 16, the radially outer magnetically non-conducting segments 24 and the magnetically conducting segments 22. Alternatively, the permanent magnets 20 may be prefabricated and inserted into spaces between the conducting segments 22 and between the non-conducting segments 16 and 24. The prefabricated magnets may be adhesively affixed within the spaces, and this structure has improved structural stability as a result of the surrounding non-conducting and conducting segments.

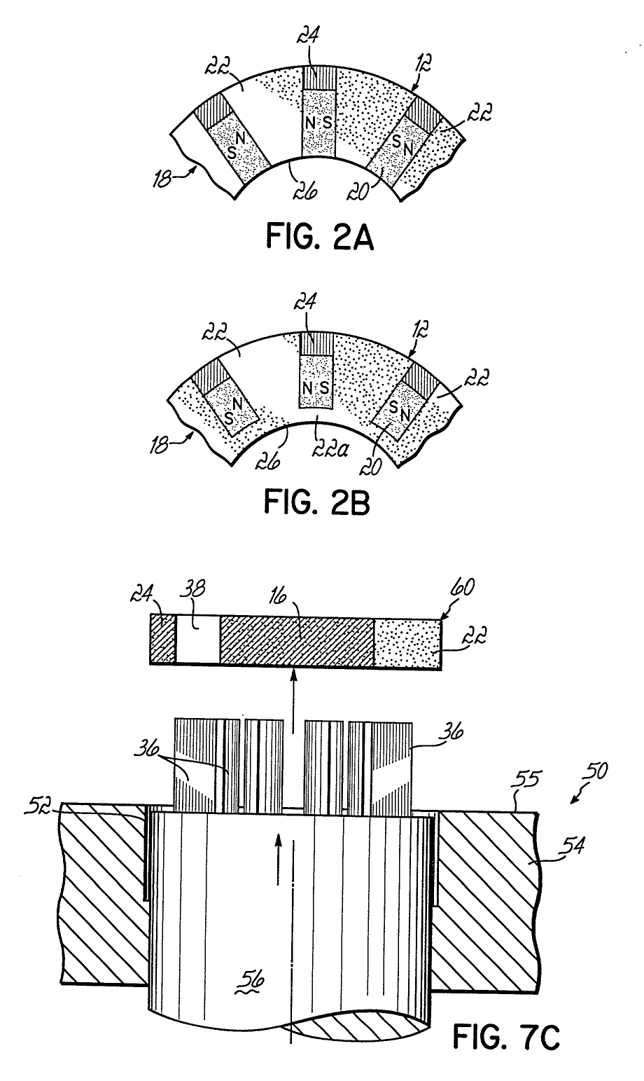

Alternatively, a spoke type rotor disk 12 can be made without the inner annular magnetically non-conducting segment 16, as depicted in FIGS. 2A-2B. Thus, the disk 12 comprises an outer annular permanent magnet segment 18 having a plurality of alternating polarity permanent magnets 20 separated by magnetically conducting segments 22 and radially embedded by magnetically non-conducting segments 24. The magnetically conducting segments 22 can be made with a continuous inner ring 22a adjacent the interior surface 26 of the disk 12, as shown in FIG. 2B. The inner ring 22a can be minimized or eliminated by machining. Magnets 20 can be prefabricated and affixed into the disk 12 or can be hard ferromagnetic powder metal compacted and sintered concurrently or sequentially with the other powder metals. Disk 12 can be assembled onto a sleeve or cylinder (not shown), with or without a separate wrought or machined shaft (not shown).

While FIGS. 1-2B depict one embodiment for a spoke type permanent magnet rotor, it should be appreciated that numerous other embodiments exist having a varying number of permanent magnets 20, and having various sizes of permanent magnets 20, as well as varying sizes for the conducting segments 22 separating the permanent magnets 20. Thus, the invention should not be limited to the particular embodiment shown in FIGS. 1-2B. It should be further understood that each embodiment described as a disk 12 could be formed as a ring, which is generally understood to have a smaller annular width and larger inner diameter than a disk. Thus, the term disk used throughout the description of the invention and in the claims hereafter is hereby defined to include a ring. Further, the term disk includes solid disks. The aperture in the center of the disk that receives the rotor shaft may be later formed, for example, by machining.

The present invention further provides a method for fabricating composite powder metal disks or rings for assembling into a rotor for a spoke type permanent magnet machine. To this end, and in accordance with the present invention, a disk-shaped die is provided having discrete regions in a pattern corresponding to the desired rotor magnetic configuration. An inner annular region is filled with a non-ferromagnetic powder metal to ultimately form the inner annular magnetically non-conducting segment of the rotor, when included. A plurality of discrete regions in an outer annular region are filled with a soft ferromagnetic powder metal to ultimately form the magnetically conducting segments. Finally, a plurality of discrete regions in the outer annular region are filled with non-ferromagnetic powder metal to ultimately form the radially outer magnetically non-conducting segments of the rotor. Inserts may be used to form spaces in which prefabricated permanent magnets may later be affixed. In an embodiment in which the permanent magnets comprise hard ferromagnetic powder metal, a plurality of discrete regions are filled with the hard ferromagnetic powder metal.

The powder metals are pressed in the die to form a compacted powder metal disk. This compacted powder metal is then sintered to form a powder metal disk or lamination having an inner annular region of magnetically non-conducting material and an outer annular region of radially extending permanent magnets separated by conducting powder metal and capped by non-conducting powder metal, the disk exhibiting high structural stability. The pressing and sintering process results in magnetically conducting segments having a density of at least 95% of theoretical density, permanent magnets having a density of at least 95.5% ± about 3.5% of theoretical density (depending on fill factor) and non-conducting segments having a density of at least 85% of theoretical density. The method for forming these rotors provides increased mechanical integrity, reduced flux leakage, more efficient flux channeling, reduced cost and simpler construction.

The method of the present invention may thus include filling a die with two or three dissimilar powder metals. At the least, the die is partially filled in discrete regions with a non-ferromagnetic powder metal, and with a soft ferromagnetic powder metal in adjacent discrete regions of the die. For other embodiments of the present invention, the die may also be filled with a hard ferromagnetic powder metal in discrete regions of the die.

In one embodiment of the present invention using two or three dissimilar powder metals, the regions in the die are filled concurrently with the various powder metals, which are then concurrently pressed and sintered. In another embodiment of the present invention also using two or three dissimilar powder metals, the regions are filled sequentially with the powder metal being pressed and then sintered after each filling step. In other words, one powder metal is filled, pressed and sintered, and then the second powder metal is filled and that assembly is pressed and sintered, and then the optional third powder metal is filled and the entire assembly is pressed and sintered.

The pressing of the filled powder metal may be accomplished by uniaxially pressing the powder in a die, for example at a pressure of about 45-50 tsi. It should be understood that the pressure needed is dependent upon the particular powder metal materials that are chosen. In a further embodiment of the present invention, the pressing of the powder metal involves heating the die to a temperature in the range of about 275° F. (135° C.) to about 290° F. (143° C.), and heating the powders within the die to a temperature about 175° F. (79° C.) to about 225° F. (107° C.).

In an embodiment of the present invention, the sintering of the pressed powder comprises heating the compacted powder metal to a first temperature of about 1400° F. (760° C.) and holding at that temperature for about one hour. Generally, the powder metal includes a lubricating material, such as a plastic, on the particles to increase the strength of the material during compaction. The internal lubricant reduces particle-to-particle friction, thus allowing the compacted powder to achieve a higher green strength after sintering. The lubricant is then burned out of the composite during this initial sintering operation, also known as a delubrication or delubing step. A delubing for one hour is a general standard practice in the industry and it should be appreciated that times above or below one hour are sufficient for the purposes of the present invention if delubrication is achieved thereby. Likewise, the temperature may be varied from the general industry standard if the ultimate delubing function is performed thereby.

After delubing, the sintering temperature is raised to a full sintering temperature, which is generally in the industry about 2050° F. (1121° C.). During this full sintering, the compacted powder shrinks, and particle-to-particle bonds are formed, generally between iron particles. Standard industry practice involves full sintering for a period of one hour, but it should be understood that the sintering time and temperature may be adjusted as necessary. The sintering operation may be performed in a vacuum furnace, and the furnace may be filled with a controlled atmosphere, such as argon, nitrogen, hydrogen or combinations thereof. Alternatively, the sintering process may be performed in a continuous belt furnace, which is also generally provided with a controlled atmosphere, for example a hydrogen/nitrogen atmosphere such as 75% H₂/25% N₂. Other types of furnaces and furnace atmospheres may be used within the scope of the present invention as determined by one skilled in the art.

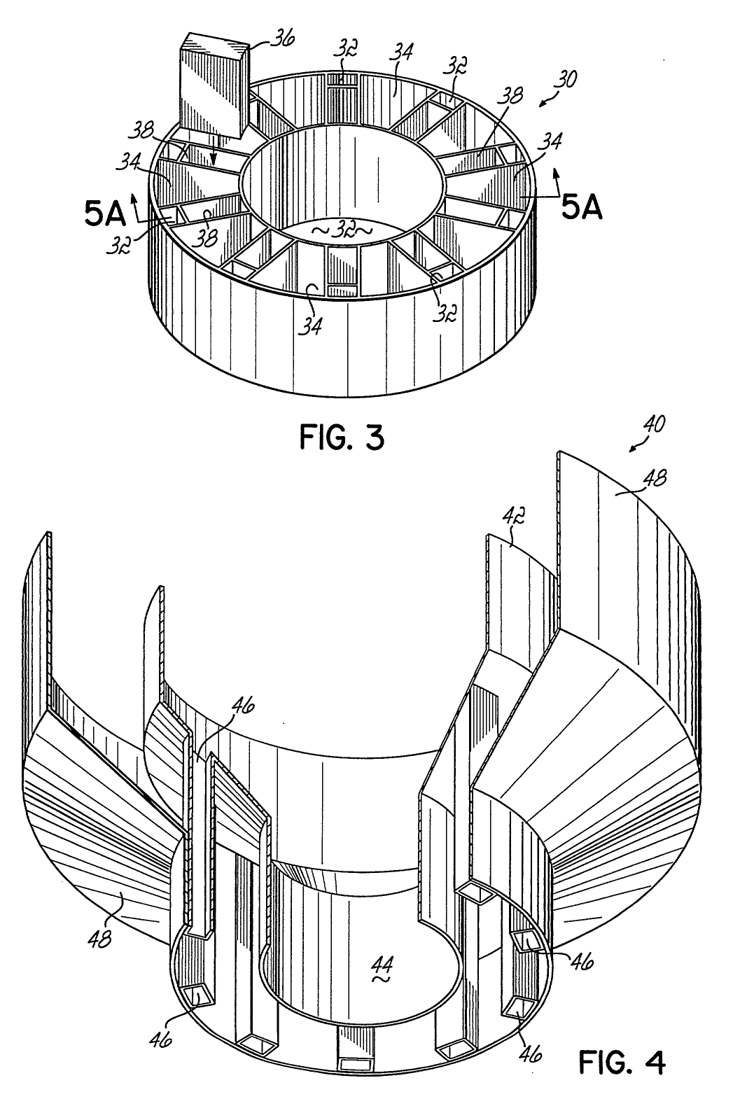

For the purpose of illustrating the method of the present invention, FIGS. 3-7C depict die inserts, hopper configurations and pressing techniques that may be used to achieve the concurrent filling or sequential filling of the powder metals arid subsequent compaction to form the composite powder metal disks of the present invention. It is to be understood, however, that these illustrations are merely examples of possible methods for carrying out the present invention.

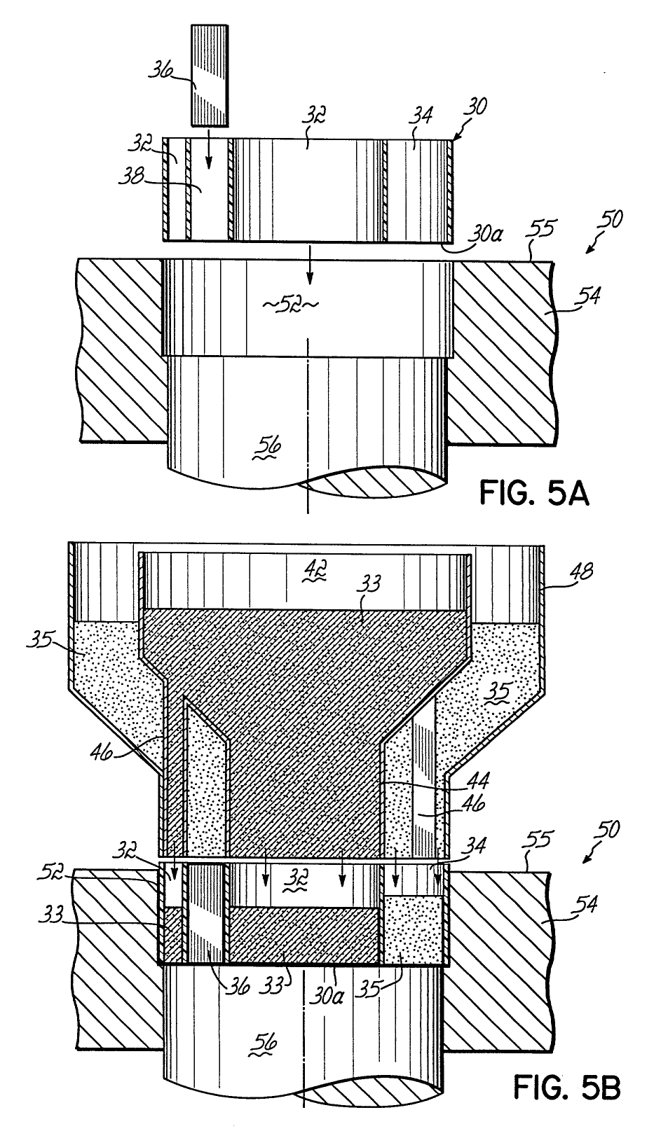

FIG. 3 depicts a die insert 30 that may be placed within a die cavity to produce the powder metal disk 12 of FIGS. 1 and 2 in which the permanent magnets are prefabricated and affixed in the composite disk after compaction and sintering of the powder metals. The two powder metals, i.e. the soft ferromagnetic and non-ferromagnetic powder metals, are filled concurrently or sequentially into the separate insert cavities 32, 34, and then the insert 30 is removed. Spacing inserts 36 may be placed in cavities 38 to form spaces between the conducting segments 22 into which the permanent magnets 20 may subsequently be inserted and affixed. By way of example only, FIG. 4 depicts a hopper assembly 40 that may be used to fill the insert 30 of FIG. 3 with the powder metals. In this assembly 40, an inner bowl 42 is provided having an annular tube 44 for forming the inner annular non-conducting segment 16 of the composite part or metal disk 12 of FIGS. 1 and 2, and a plurality of tubes 46 for forming the radially outer non-conducting segments 24 in the outer annular permanent magnet segment 18. This inner bowl 42 is adapted to hold and deliver the non-ferromagnetic powder metal. An outer bowl 48 is positioned around the inner bowl 42 for forming the magnetically conducting segments 22. This outer bowl 48 is adapted to hold and deliver soft ferromagnetic powder metal. This dual hopper assembly 40 enables either concurrent or sequential filling of the die insert of FIG. 3.

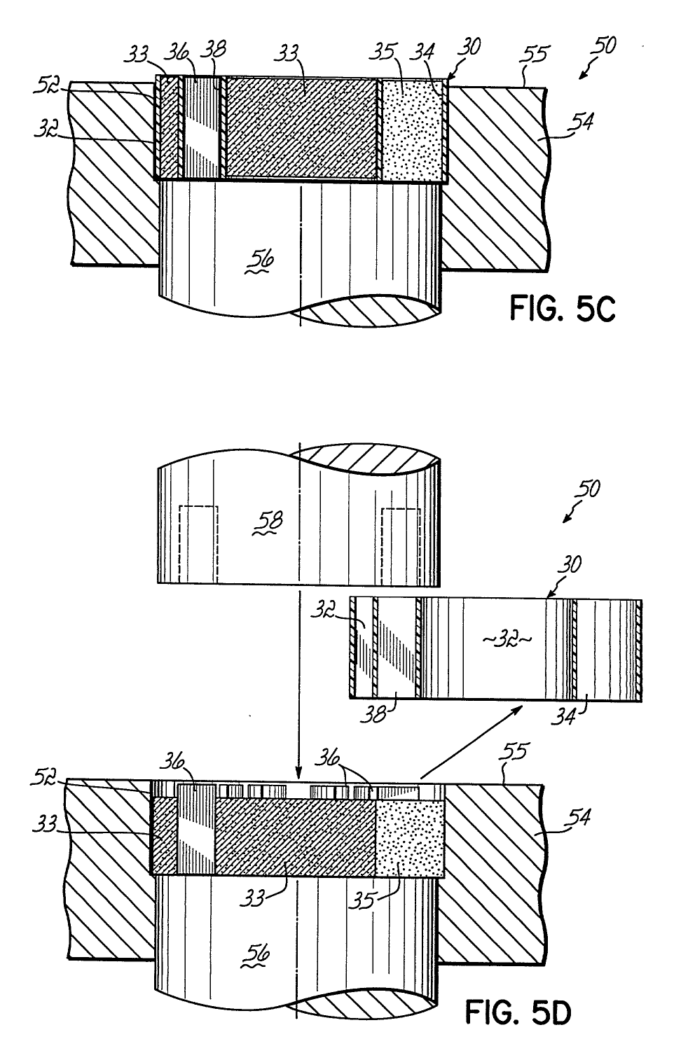

FIGS. 5A-5E depict schematic views in partial cross-section taken along line 5A-5A of FIG. 3 of how the die insert 30 of FIG. 3 and the hopper assembly 40 of FIG. 4 can be used with an uniaxial die press 50 to produce the composite powder metal disk 12 of FIGS. 1 and 2. In this method, the die insert 30 is placed within a cavity 52 in the die 54, as shown in FIG. 5A, with a lower punch 56 of the press 50 abutting the bottom 30a of the insert 30. The hopper assembly 40 is placed over the insert 30 and the powder metals 33,35 are filled into the insert cavities 32,34, concurrently or sequentially, as shown in FIG. 5B. The hopper assembly 40 is then removed, leaving a filled insert 30 in the die cavity 52, as shown in FIG. 5C. Then the insert 30 is lifted out of the die cavity 52, which causes some settling of the powder, as seen in FIG. 5D. The upper punch 58 of the press 50 is then lowered down upon the powder-filled die cavity 52, as shown by the arrow in FIG. 5D, to uniaxially press the powders in the die cavity 52. The final composite part 60 is then ejected from the die cavity 52 by raising the lower punch 56 and the spacing inserts 36 are removed. The part 60 is next transferred to a sintering furnace (not shown). Where the filling is sequential, the first powder is poured into either the inner bowl 42 or outer bowl 48, and a specially configured upper punch 58 is lowered so as to press the filled powder, and the partially filled and compacted insert (not shown) is sintered. The second fill is then effected and the insert 30 removed for pressing, ejection and sintering of the complete part 60.

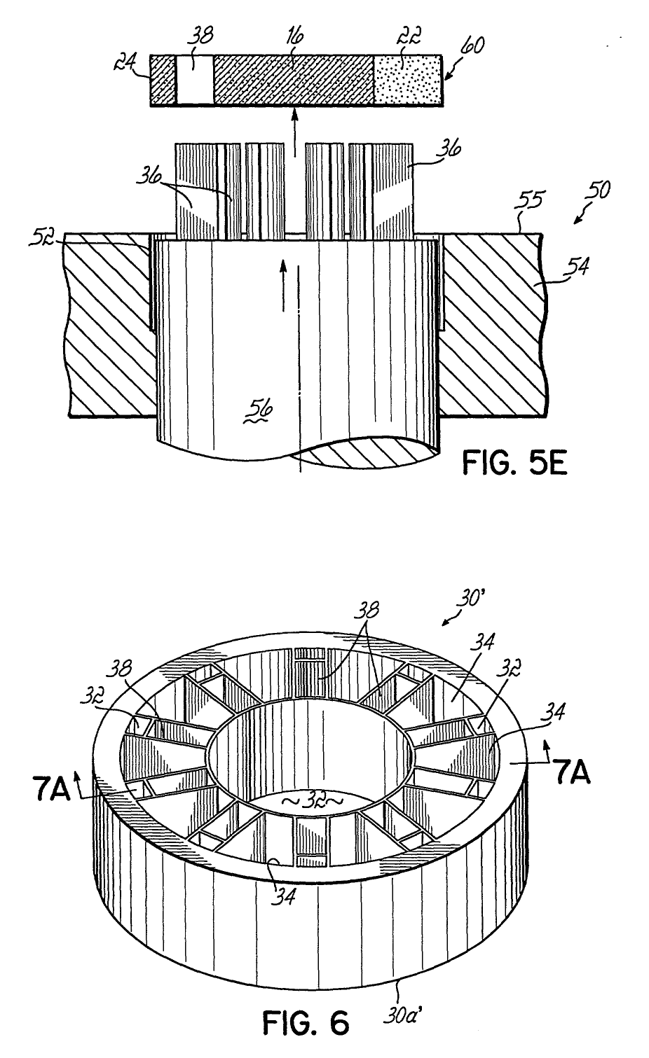

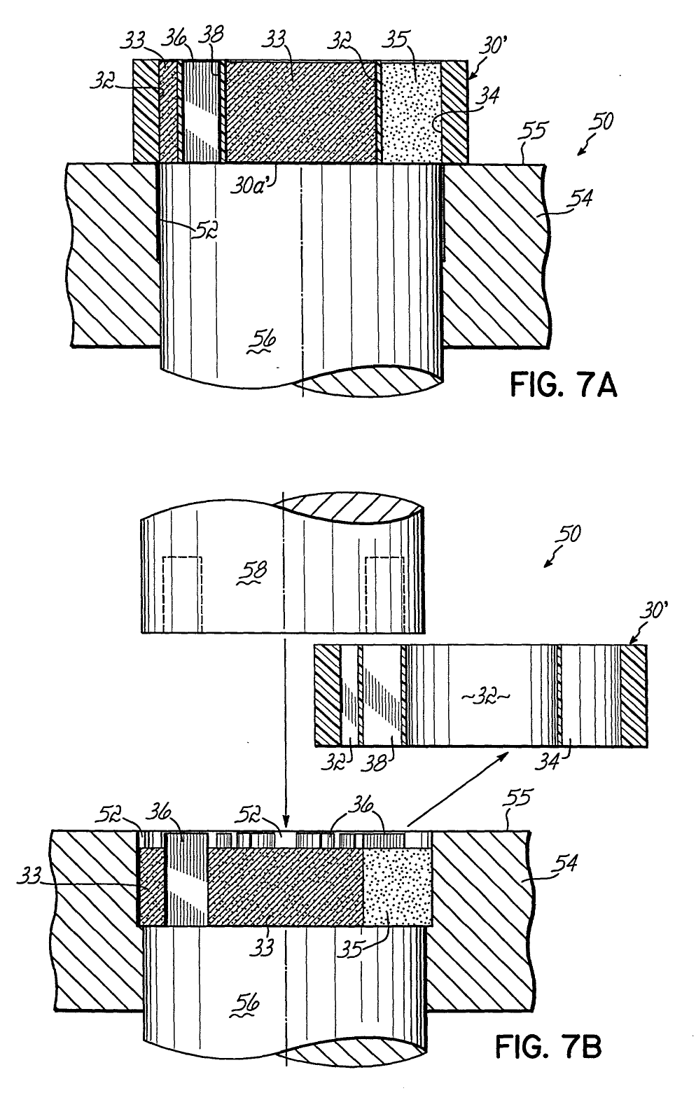

FIG. 6 depicts an alternative die insert 30′ that may be placed on a top surface 55 of the die 54 over the die cavity 52 to form the powder metal disk 12 depicted in FIGS. 1 and 2. FIGS. 7A-7C show in partial cross-section taken along line 7A-7A of FIG. 6 the method for using the insert 30′ of FIG. 6. The insert is set on top surface 55 of the die 54 over the cavity 52 with the lower punch 56 in the ejection position, as shown in FIG. 7A. The powder metals 33,35 are then filled into the insert 30′, either concurrently or sequentially, as shown in FIG. 5B, and the lower punch 56 is then lowered to the fill position. The lowering of the punch 56 forms a vacuum which pulls the powder metals 33, 35 out of the bottom 30a′ of the insert 30′ and into the die cavity 52, as shown in FIG. 7B. The insert 30′ is then removed from the top surface 55 of the die 54, and the upper punch 58 is lowered into the die cavity 52 to compact the powder metals 33,35. The lower punch 56 is then raised to eject the final composite part 60, as shown in FIG. 7C, and the part 60 is then transferred to a sintering furnace (not shown). Where the filling is sequential, dummy placement segments (not shown) may be used if needed for the first filling/pressing/sintering sequence, which can then be removed to effect the filling of the second powder metal.

In one embodiment of the present invention, pneumatic air hammers or tappers (not shown) may be placed on, in, or around the inserts 30, 30′ used in either the method depicted in FIGS. 5A-5E or the method depicted in FIGS. 7A-7C. The vibrating of the insert 30,30′ enables the powder metal 33,35 to flow out of the insert 30,30′ with greater ease as the insert 30,30′ is removed, and further enables a greater tap density. In another embodiment of the present invention, a dry lube is sprayed or added to the inside of the insert cavities 32,34 used in either of those methods. Again, this dry lube helps to improve the flow of the powder metals 33,35 out of the insert 30,30′. In yet another embodiment of the present invention, heaters and thermocouples (not shown) may be used in conjunction with the insert 30,30′. The heat keeps the powder warm, if warm compaction is being optimized, and again allows the powder metals 33,35 to more easily flow out of the insert 30,30′.

It should be further understood that while the methods shown and described herein are discussed with respect to forming a solid composite disk in which an aperture may be machined in the center after compaction and sintering for receiving the shaft of a rotor assembly, the composite part may be formed as a disk with the aperture already formed in the center. Likewise, the outer annular segment 18 may be first formed as a solid ring of pressed and sintered soft ferromagnetic and non-ferromagnetic powder metals, then machined to form spaces into which permanent magnets may be inserted.

For an embodiment of the present invention in which the permanent magnets are pressed and sintered hard ferromagnetic powder metal separated by non-conducting segments, a three-hopper assembly may be used to achieve a tri-fill process. Insert cavities 38 would be filled with the hard ferromagnetic powder metal. As with the dual-fill processes described above, the tri-fill process can include concurrent filling of the powder metals or sequential filling of the powder metals.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. For example, variations in the hopper assembly, filling method and die inserts may be employed to achieve a composite powder metal disk of the present invention, and variations in the magnetic configuration of the disks other than that shown in the Figures herein are well within the scope of the present invention. The invention in its broader aspects is therefore not limited to the specific details, representative apparatuses and methods and illustrative examples shown and described. Accordingly, departures may be made from such details without departing from the scope or spirit of applicant's general inventive concept.

What is claimed is:

1. A method of making a powder metal rotor for a spoke type interior permanent magnet machine, the method comprising:
filling discrete first regions within an outer annular region of a disk-shaped die with a soft ferromagnetic powder metal so as to leave spaces between each discrete first region;
filling discrete radially outer second regions between the first regions with a non-ferromagnetic powder metal so as to leave a radially inner radially extending space between each of the adjacent first regions;
pressing the powders in the die to form a compacted powder metal disk;
sintering the compacted powder metal disk; and
providing permanent magnets in the radially extending spaces between the discrete first regions of the outer annular region in an arrangement of alternating polarity to form a composite powder metal disk having an outer annular segment of a plurality of alternating polarity permanent magnets separated by magnetically conducting segments and radially embedded by magnetically non-conducting segments.

2. The method of claim 1 further comprising filling an inner annular region of the die with a non-ferromagnetic powder metal to form the disk having further an inner annular magnetically non-conducting segment.

3. The method of claim 1, wherein the discrete first regions are filled so as to form a continuous ring radially inward of the spaces.

4. The method of claim 1, wherein the discrete first and second regions are filled concurrently.

5. The method of claim 1, wherein the discrete first and second regions are filled sequentially with the powder metal being pressed and sintered after each filling step.

6. The method of claim 1, wherein the providing of permanent magnets includes affixing prefabricated permanent magnets to the adjacent magnetically conducting segments.

7. The method of claim 1, wherein the providing of permanent magnets includes filling the radially extending spaces with a hard ferromagnetic powder metal, pressing the hard ferromagnetic powder metal and sintering the pressed powder.

8. The method of claim 7, wherein the discrete first and second regions and radially extending spaces are filled concurrently.

9. The method of claim 7, wherein the discrete first and second regions and radially extending spaces are filled sequentially with the powder metal being pressed and sintered after each filling step.

10. The method of claim 1, wherein the soft ferromagnetic powder metal is Ni, Fe, Co or an alloy thereof.

11. The method of claim 1, wherein the soft ferromagnetic powder metal is a high purity iron powder with a minor addition of phosphorus.

12. The method of claim 1, wherein the non-ferromagnetic powder metal is an austenitic stainless steel.

13. The method of claim 1, wherein the non-ferromagnetic powder metal is an AISI 8000 series steel.

14. The method of claim 1, wherein the pressing comprises uniaxially pressing the powders in the die.

15. The method of claim 1, wherein the pressing comprises pre-heating the powders and pre-heating the die.

16. The method of claim 1, wherein, after the pressing, the compacted powder metal disk is delubricated at a first temperature, followed by sintering at a second temperature greater than the first temperature.

17. A method of making a powder metal rotor for a spoke type interior permanent magnet machine, the method comprising:
filling an inner annular region of a disk-shaped die with a non-ferromagnetic powder metal;
filling discrete first regions within an outer annular region of the die with a soft ferromagnetic powder metal so as to leave spaces between each discrete first region;
filling discrete radially outer second regions between the first regions with a non-ferromagnetic powder metal so as to leave a radially inner radially extending space between each of the adjacent first regions;
pressing the powders in the die to form a compacted powder metal disk;
sintering the compacted powder metal disk; and
providing permanent magnets in the radially extending spaces between the discrete first regions of the outer annular region in an arrangement of alternating polarity to form a composite powder metal disk having an inner annular magnetically non-conducting segment and an outer annular segment of a plurality of alternating polarity permanent magnets separated by magnetically conducting segments and embedded by magnetically non-conducting segments.

18. The method of claim 17, wherein the inner annular region and discrete first and second regions are filled concurrently.

19. The method of claim 17, wherein the inner annular region and discrete first and second regions are filled sequentially with the powder metal being pressed and sintered after each filling step.

20. The method of claim 17, wherein the providing of permanent magnets includes affixing prefabricated permanent magnets to the inner annular segment and to adjacent magnetically conducting segments.

21. The method of claim 17, wherein the providing of permanent magnets includes filling the radially extending spaces with a hard ferromagnetic powder metal, pressing the hard ferromagnetic powder metal and sintering the pressed powder.

22. The method of claim 21, wherein the inner annular region, discrete first and second regions and radially extending spaces are filled concurrently.

23. The method of claim 21, wherein the inner annular region, discrete first and second regions and radially extending spaces are filled sequentially with the powder metal being pressed and sintered after each filling step.

24. The method of claim 17, wherein the soft ferromagnetic powder metal is Ni, Fe, Co or an alloy thereof.

25. The method of claim 17, wherein the soft ferromagnetic powder metal is a high purity iron powder with a minor addition of phosphorus.

26. The method of claim 17, wherein the non-ferromagnetic powder metal is an austenitic stainless steel.

27. The method of claim 17, wherein the non-ferromagnetic powder metal is an AISI 8000 series steel.

28. The method of claim 17, wherein the pressing comprises uniaxially pressing the powders in the die.

29. The method of claim 17, wherein the pressing comprises pre-heating the powders and pre-heating the die.

30. The method of claim 17, wherein, after the pressing, the compacted powder metal disk is delubricated at a first temperature, followed by sintering at a second temperature greater than the first temperature.

31. The method of claim 17, wherein the sintering is performed in a vacuum furnace having a controlled atmosphere.

32. The method of claim 17, wherein the sintering is performed in a belt furnace having a controlled atmosphere.

33. The method of claim 17 further comprising stacking a plurality of the composite powder metal disks axially along a shaft to form a powder metal rotor assembly.

34. A method of making a powder metal rotor for a spoke type interior permanent magnet machine, the method comprising:
filling an inner annular region and a plurality of first portions of an outer annular region of a disk-shaped die with a non-ferromagnetic powder metal;
pressing and sintering the non-ferromagnetic powder metal in the die to form a compacted and sintered inner annular magnetically non-conducting segment and a plurality of compacted and sintered outer magnetically non-conducting segments;
filling a plurality of second portions in the outer region of the die with a soft ferromagnetic powder metal, the second portions being in alternating relation with the outer magnetically non-conducting segments;
pressing the soft ferromagnetic powder metal in the die to form a plurality of compacted magnetically conducting segments;
sintering the compacted magnetically conducting segments and the compacted and sintered inner annular and outer magnetically non-conducting segments; and
providing radially extending permanent magnets in a plurality of radially inner third portions in the outer region between the magnetically conducting segments in an arrangement of alternating polarity to form a composite powder metal disk having an inner annular magnetically non-conducting segment and an outer annular segment of a plurality of alternating polarity permanent magnets separated by magnetically conducting segments and embedded by magnetically non-conducting segments.

35. The method of claim 34, wherein the providing step includes, after the second sintering step, filling the third portions with a hard ferromagnetic powder metal, pressing the hard ferromagnetic powder metal in the die to form a plurality of compacted permanent magnet segments, and sintering the compacted permanent magnet segments and the compacted and sintered magnetically conducting segments and magnetically non-conducting segments.

36. The method of claim 34 further comprising affixing prefabricated permanent magnets of alternating polarity in the third portions between the magnetically conducting segments.

37. The method of claim 34, wherein the soft ferromagnetic powder metal is Ni, Fe, Co or an alloy thereof.

38. The method of claim 34, wherein the soft ferromagnetic powder metal is a high purity iron powder with a minor addition of phosphorus.

39. The method of claim 34, wherein the non-ferromagnetic powder metal is an austenitic stainless steel.

40. The method of claim 34, wherein the non-ferromagnetic powder metal is an AISI 8000 series steel.

41. The method of claim 34, wherein each pressing comprises uniaxially pressing the powder in the die.

42. The method of claim 34, wherein each pressing comprises pre-heating the powder and pre-heating the die.

43. The method of claim 34, wherein, after each pressing, the compacted segments are delubricated at a first temperature, followed by sintering at a second temperature greater than the first temperature.

44. The method of claim 34, wherein each sintering is performed in a vacuum furnace having a controlled atmosphere.

45. The method of claim 34, wherein each sintering is performed in a belt furnace having a controlled atmosphere.

46. The method of claim 34 further comprising stacking a plurality of the composite powder metal disks axially along a shaft to form a powder metal rotor assembly.

47. A powder metal disk for a rotor assembly in a spoke type interior permanent magnet machine, the disk comprising a plurality of magnetically conducting segments of pressed and sintered soft ferromagnetic powder metal separated by a plurality of alternating polarity, radially extending permanent magnets each with a magnetically non-conducting segment of pressed and sintered non-ferromagnetic powder metal extending from a radially outer end of each permanent magnet to an outer circumferential surface of the disk.

48. The disk of claim 47 further comprising an inner annular magnetically non-conducting segment of pressed and sintered non-ferromagnetic powder metal adjacent a radially inner end of each permanent magnet.

49. The disk of claim 47, wherein the soft ferromagnetic powder metal is Ni, Fe, Co or an alloy thereof.

50. The disk of claim 47, wherein the soft ferromagnetic powder metal is a high purity iron powder with a minor addition of phosphorus.

51. The disk of claim 47, wherein the non-ferromagnetic powder metal is an austenitic stainless steel.

52. The disk of claim 47, wherein the non-ferromagnetic powder metal is an AISI 8000 series steel.

53. The disk of claim 47, wherein the permanent magnets comprise pressed and sintered hard ferromagnetic powder metal.

54. The disk of claim 47, wherein the permanent magnets are prefabricated inserts adhesively bonded to the magnetically conducting segments.

55. A powder metal disk for a rotor assembly in a spoke type interior permanent magnet machine, the disk comprising:
an inner annular magnetically non-conducting segment of pressed and sintered non-ferromagnetic powder metal; and
an outer annular permanent magnet segment comprising a plurality of magnetically conducting segments of pressed and sintered soft ferromagnetic powder metal separated by a plurality of alternating polarity, radially extending permanent magnets each with a magnetically non-conducting segment of pressed and sintered non-ferromagnetic powder metal extending from a radially outer end of each permanent magnet to an outer circumferential surface of the disk.

56. The disk of claim 55, wherein the soft ferromagnetic powder metal is Ni, Fe, Co or an alloy thereof.

57. The disk of claim 55, wherein the soft ferromagnetic powder metal is a high purity iron powder with a minor addition of phosphorus.

58. The disk of claim 55, wherein the non-ferromagnetic powder metal is an austenitic stainless steel.

59. The disk of claim 55, wherein the non-ferromagnetic powder metal is an AISI 8000 series steel.

60. The disk of claim 55, wherein the permanent magnets comprise pressed and sintered hard ferromagnetic powder metal.

61. The disk of claim 55, wherein the permanent magnets are prefabricated inserts adhesively bonded to the inner annular magnetically non-conducting segment.

62. A powder metal disk for a rotor assembly in a spoke type interior permanent magnet machine, the disk comprising:
an inner annular magnetically non-conducting segment of pressed and sintered non-ferromagnetic powder metal; and
an outer annular permanent magnet segment comprising a plurality of magnetically conducting segments of pressed and sintered soft ferromagnetic powder metal separated by a plurality of alternating polarity, radially extending permanent magnets of pressed and sintered hard ferromagnetic powder metal each with a magnetically non-conducting segment of pressed and sintered non-ferromagnetic powder metal extending from a radially outer end of each permanent magnet to an outer circumferential surface of the disk.

63. The disk of claim 62, wherein the soft ferromagnetic powder metal is Ni, Fe, Co or an alloy thereof.

64. The disk of claim 62, wherein the soft ferromagnetic powder metal is a high purity iron powder with a minor addition of phosphorus.

65. The disk of claim 62, wherein the non-ferromagnetic powder metal is an austenitic stainless steel.

66. The disk of claim 62, wherein the non-ferromagnetic powder metal is an AISI 8000 series steel.

67. A powder metal rotor assembly for a spoke type interior permanent magnet machine, comprising:
a shaft; and
a plurality of composite powder metal disks axially stacked along and affixed to the shaft, each disk comprising:
(a) an inner annular magnetically non-conducting segment of pressed and sintered non-ferromagnetic powder metal; and
(b) an outer annular permanent magnet segment comprising a plurality of magnetically conducting segments of pressed and sintered soft ferromagnetic powder metal separated by a plurality of alternating polarity, radially extending permanent magnets each with a magnetically non-conducting segment of pressed and sintered non-ferromagnetic powder metal extending from a radially outer end of each permanent magnet to an outer circumferential surface of the disk.

68. The assembly of claim 67, wherein the soft ferromagnetic powder metal is Ni, Fe, Co or an alloy thereof.

69. The assembly of claim 67, wherein the soft ferromagnetic powder metal is a high purity iron powder with a minor addition of phosphorus.

70. The assembly of claim 67, wherein the non-ferromagnetic powder metal is an austenitic stainless steel.

71. The assembly of claim 67, wherein the non-ferromagnetic powder metal is an AISI 8000 series steel.

72. The assembly of claim 67, wherein the permanent magnets comprise pressed and sintered hard ferromagnetic powder metal.

73. The assembly of claim 67, wherein the permanent magnets are prefabricated inserts adhesively bonded to the inner annular magnetically conducting segment.
